(19) United States
(12) Patent Application Publication
(10) Pub. No.: US 2024/0217827 A1
(43) Pub. Date: Jul. 4, 2024

(54) GRAPHENE-BASED NANODEMULSIFIER

(71) Applicant: YPF TECNOLOGÍA S.A., Ciudad Autónoma de Buenos Aires (AR)

(72) Inventors: Nicolas Alberto GARCIA SAGGION, Ciudad Autónoma de Buenos Aires (AR); Albert Ulises SAAVEDRA OLAYA, La Matanza Prov. de Buenos Aires (AR); María Mercedes MESSINA, La Plata (AR); María Jesús GONZALEZ PABÓN, Ciudad Autónoma de Buenos Aires (AR); Isabel Natalia VEGA, Ciudad Autónoma de Buenos Aires (AR)

(21) Appl. No.: 18/403,414

(22) Filed: Jan. 3, 2024

Related U.S. Application Data
(60) Provisional application No. 63/436,989, filed on Jan. 4, 2023.

(51) Int. Cl. C01B 32/198; C01B 32/184; C01B 32/194; C10G 33/04

(52) U.S. Cl. CPC C01B 32/198; C01B 32/184; C01B 32/194; C10G 33/04; C01P 2002/01; C01P 2002/82; C01P 2004/04

(57) ABSTRACT

The present description discloses a nanodemulsifier comprising graphene oxide nanoparticles functionalized with L-glycine, as well as methods for the preparation and use thereof. The nanodemulsifier herein disclosed exhibits excellent demulsifying capabilities for emulsions typically found in the oil & gas industry.

### FIELD OF THE INVENTION

The present invention generally relates to the field of Oil & Gas (O&G) industry. In particular, the invention refers to a demulsifier which may be used for separating oil and water from a crude oil emulsion obtained from an extraction well.

### BACKGROUND OF THE INVENTION

Water produced during crude oil extraction process in the O&G industry may be in free form or emulsified with the crude oil. During the production process of the hydrocarbon, the two phases (i.e., water and oil) become mixed with one another, forming emulsions which may be very stable. Depending on the physicochemical characteristics of the fluids and the operational conditions, the formed emulsions may exhibit different stability states between water and oil, which may pose the need for complex separation processes involving expensive facilities, a high amount of energy, and the use of specific chemical products depending on the characteristics of each emulsion (Kokal, 2005).

Water-in-oil (W/O) and oil-in-water (O/W) emulsions are a pending problem in oil operations in crude oil treatment plants (OTP) and water treatment plants (WTP), both in upstream (conventional and non-conventional) and downstream processes. The development of different demulsifier chemical formulations has been a recurring subject in the field.

Emulsions may exhibit different types of stability, depending on the amount of emulgents present in the oil (polar compounds, asphaltenes, resins, among others), which may be accompanied by inorganic solids, microorganisms, etc.

Among the traditional processes for separating emulsions used in the O&G industry, flotation (Moosai and Dawe, 2003; Rubio et al., 2002), coagulation (Ahmad et al., 2006; Li et al., 2003), biological treatments (Kriipsalu et al., 2007), separating membranes (Safarpour et al., 2015; Zhang et al., 2009), electrochemical separation and treatments with chemical disruptors (Yu et al., 2017) may be found.

There is a great variety of existing demulsifiers. Generally, they are molecules capable of interacting in the water/oil interface, that is, they are characterized by being amphiphilic compounds (i.e., molecules having both hydrophobic and hydrophilic ends), which are intended to displace the emulgents in emulsions and decrease the interfacial tension of the crude oil. This decrease in the interfacial tension allows for the coalescence of each phase, thus generating the separation thereof.

A special type of demulsifiers is the one based on amino acids. In these demulsifiers, the amino acids, along with an alkyl chain and a sulfonated anion, interact directly with the stabilizers of the emulsion interface, thus producing its break. These demulsifiers have been used in clinical environments, exhibiting also antimicrobial properties (Holmberg, 2003; Pinazo et al., 2016). In the O&G industry, U.S. Pat. No. 9,677,009 refers to the use of glycine modified with a hydrocarbon chain as a demulsifier.

In recent years, the use of nanoparticles composed by graphene oxide (GO) as a demulsifying agent has been studied by several researchers (Contreras Ortiz et al., 2019; Fang et al., 2016; J. Liu et al., 2015; Wang et al., 2016), due to the great adsorption capabilities exhibited by the GO nanosheets in the oil-water interface, favored by the TT-IT interactions with the asphaltenes and resins present in the oil. Based on this principle, Ortiz et al. obtained a GO suspension which, when tested with emulsified crude oils, generated a slow demulsification, comparable to those obtained with commercial chemical products. Similarly, patent applications such as CN104877706A and CN106219669A refer to the use of GO for breaking crude oil/water emulsions.

The demulsifying effect of GO may be enhanced by the modification of the nanoparticles with some functional groups such as amino groups (GO-A), which increase their dispersion in the oil phase (Jang et al., 2014). These suspensions were also tested in Enhanced Oil Recovery (EOR), obtaining promising results in the increase of the oil recovery factor in laboratory assays (Radnia et al., 2018). Patent application CN111285435A refers to chitosan-functionalized GO for demulsifying O/W and W/O emulsions. Patent application CN111892945A, on the other hand, refers to a SiO₂-functionalized GO demulsifier.

However, there is a constant need for new compositions and methods for demulsifying crude oil and water emulsions obtained from the oil extraction process in field work in a fast, unexpensive and easily scalable manner.

### SUMMARY OF THE INVENTION

The present invention describes a nanodemulsifier comprising graphene oxide (GO) nanoparticles functionalized with L-glycine, wherein the GO nanoparticles have a C/O ratio from about 3 to about 6 before being functionalized. Preferably, the GO nanoparticles have a C/O ratio from about 3 to about 4 before being functionalized.

Another aspect of the invention is to provide a demulsifying composition comprising a nanodemulsifier comprising GO nanoparticles functionalized with L-glycine according to the invention dispersed in a carrier.

In a preferred embodiment of this aspect of the invention, the GO nanoparticles functionalized with L-glycine are present in a concentration from about 1000 to about 20000 ppm in the composition. Most preferably, the GO nanoparticles functionalized with L-glycine are present in a concentration of about 10000 ppm in the composition.

Another aspect of the present invention is to provide a method for preparing a nanodemulsifier, comprising:
i—electrochemically exfoliating a graphite electrode under electrolyte recirculation conditions, thus obtaining GO; and
ii—functionalizing the GO obtained in step i—with L-glycine.

Preferably, step i—is carried out in a neutral medium. More preferably, the neutral medium comprises (NH₄)₂SO₄ as electrolyte for the electrochemical exfoliation.

In a particular embodiment of this aspect of the invention, step ii—comprises suspending the GO obtained in step i—in water and dissolving L-glycine therein, wherein the GO:L-glycine ratio is 1:1.

In a particular embodiment of this aspect of the invention, the graphite electrode comprises industrial grade graphite. Preferably, when the graphite electrode comprises industrial grade graphite, the method comprises an additional step performed prior to step i-, wherein the graphite electrode is subjected to a cleaning process. More preferably, the cleaning process comprises: washing with H₂SO₄ at about 60° C., washing with NaOH 1M at about 60° C., and washing with distilled water.

It is yet another aspect of the invention to provide a method for demulsifying an emulsion comprising crude oil and water, comprising:
i—providing a demulsifying composition according to the invention; and
ii—applying the demulsifying composition to the emulsion.

In a particular embodiment of this aspect of the invention, the emulsion is selected from a W/O emulsion and an O/W emulsion.

In another particular embodiment of the invention, the demulsifying composition is applied to the emulsion in an amount such that the nanodemulsifier comprising GO nanoparticles functionalized with L-glycine is present at the emulsion in a concentration from about 10 to about 200 ppm. Preferably, the demulsifying composition is applied to the emulsion in an amount such that the nanodemulsifier comprising GO nanoparticles functionalized with L-glycine is present at the emulsion in a concentration from about 100 to about 150 ppm. Most preferably, the demulsifying composition is applied to the emulsion in an amount such that the nanodemulsifier comprising GO nanoparticles functionalized with L-glycine is present at the emulsion in a concentration from about 100 to about 120 ppm.

In another embodiment of this aspect of the invention, the method further comprises applying ultrasound to the emulsion after the demulsifying composition has been applied thereto.

In another embodiment of this aspect of the invention, the emulsion comprising crude oil and water to be demulsified is a slop oil, and the demulsifying method of the invention comprises:
i—providing a demulsifying composition according to the invention; and
ii—applying the demulsifying composition to the emulsion;
   wherein the demulsifying composition is applied to the emulsion in an amount such that the nanodemulsifier comprising GO nanoparticles functionalized with L-glycine is present at the emulsion in a concentration from about 100 to 2000 ppm, preferably of about 1000 ppm.

Preferably, when the emulsion comprising crude oil and water to be demulsified is a slop oil, the demulsifying method further comprises applying ultrasound to the emulsion after the demulsifying composition has been applied thereto.

### BRIEF DESCRIPTION OF THE DRAWINGS

FIG. 1. A) Light-field TEM image corresponding to a GO sample, wherein carbon nanotubes and graphene flakes with folded regions may be observed. B) HRTEM image in a region close to the one defined by the circle in image A, wherein arrows indicate the presence of carbon dots. C) Zoomed HRTEM image corresponding to the area within the square depicted in image B, along with the corresponding Fourier transform in the inset. D) HRTEM image corresponding to graphene layers revealing a turbostratic structure, along with its corresponding Fourier transform in the inset.

FIG. 2. Efficiencies of different amino acids in breaking LF06 emulsion.

FIG. 3. UV-vis characterization of GO and GO functionalized with L-glycine.

FIG. 4. Demulsifying efficiency: (Left) Different concentrations of GO, L-glycine and GO functionalized with glycine. (Right) Different pHs for GO, L-glycine and GO functionalized with glycine. Concentrations used: 1.33 mg/mL GO and L-glycine, and 0.03 mg/ml (30 ppm) GO functionalized with glycine.

FIG. 5. Demulsifying process: (A) Emulsified and demulsified LF06 crude oil. (B) Microscopic view of emulsified crude oil. (C) Microscopic view of demulsified crude oil. (D) Microscopic view of the interface of the demulsified crude oil. (E) Microscopic view of the aqueous phase of the demulsified crude oil. The black line in the microscopic views shows the scale (200 nm).

FIG. 6. Hydrocarbon fractions obtained by chromatography of emulsified and demulsified LF06 crude oil.

FIG. 7. Current behavior during the electrochemical production of GO in presence and absence of electrolyte recirculation.

FIG. 8. Raman spectra showing different oxidation states obtained by electrochemical exfoliation in presence and absence of electrolyte recirculation. A. Without recirculation. B. With recirculation.

FIG. 9. TEM and HRTEM images showing GO flakes obtained by neutral exfoliation under electrolyte recirculation conditions. The molecular structure of the graphene network may be appreciated. (Left) Bright field TEM image wherein graphene layers may be observed, with folded regions. (Center) HRTEM image wherein graphene flakes with folded edges may be observed. The upper intensity profile indicates the number of layers in the indicated zone. (Right) Fourier transform of the center image.

FIG. 10. Demulsion assays with GO nanoparticles functionalized with L-glycine obtained at +/−10 V (100 ppm), and with and without added Tween 20.

FIG. 11. Assays on a synthetic emulsion. Left: Demulsion for different concentrations of the demulsifier of the invention and isopropyl alcohol alone (control), after stirring and one hour at 50° C. Right: Demulsion at 10 ppm of the demulsifier of the invention and a commercially available demulsifier.

FIG. 12. SLOP demulsion by the demulsifier of the invention.

FIG. 13. SLOP demulsion by the demulsifier of the invention applying ultrasound.

FIG. 14. Demulsion of a synthetic 5% O/W emulsion at 50° C., using different concentrations of the demulsifier of the invention.

### DETAILED DESCRIPTION OF THE INVENTION

The present application discloses a nanodemulsifier comprising graphene oxide nanoparticles functionalized with L-glycine. The present inventors have found that such a nanodemulsifier unexpectedly exhibits excellent demulsifying properties for complex crude oil and water emulsions.

Within this description, the term “nanodemulsifier” is to be understood as referring to a particulated agent with the capability to properly demulsify an emulsion, wherein the particles constituting the demulsifier have sizes in the range of nanometers to micrometers. According to the invention, the particles of the nanodemulsifier are graphene oxide (GO) nanoparticles, which may take different shapes and sizes. For instance, the GO nanoparticles may be in the form of flakes, with varying sizes but typically not exceeding a cross length of 50 μm.

“Graphene oxide” (GO), as understood according to the present description, refers to the compound typically obtained by oxidation of graphite, either by the application of oxidizing compounds, or by applying an oxidizing current to a graphite electrode, which consists of discrete layers of graphene with different degrees of oxidized groups dispersed within each layer. The oxidization degree of GO is strongly dependent on the process by which it is obtained, and it is typically characterized by the carbon/oxygen (C/O) ratio of the compound. Such C/O ratio may be determined by spectroscopic techniques, such as, for example, X-ray photoelectron spectroscopy (XPS). Preferably, the nanodemulsifier of the invention comprises GO nanoparticles with a C/O ratio from about 3 to about 6, more preferably from about 3 to about 4.

According to the present invention, the nanodemulsifier comprises GO nanoparticles functionalized with L-glycine. The term “GO nanoparticles functionalized with L-glycine” refers to the obtained compound after subjecting GO nanoparticles to a treatment with L-glycine in an appropriate carrier under conditions such that the L-glycine binds to the GO oxide nanoparticles to some extent. As it is evident from the examples included in the present description, the functionalization may be determined by spectroscopic measurements of the GO and functionalized GO particles, for example, by XPS. Particularly, it should be noted that the functionalization with L-glycine reduces the GO particles to some extent, which is why the functionalization degree of the GO particles may be characterized by the C/O ratio thereof after functionalization, which usually increases in comparison to its pre-functionalization value. Preferably, the nanodemulsifier of the invention comprises GO nanoparticles functionalized with L-glycine with a C/O ratio from about 4 to about 7. In a particularly preferred embodiment, the nanodemulsifier of the invention comprises GO nanoparticles functionalized with L-glycine with a C/O ratio from about 4 to about 6.

Kumar, A., & Khandelwal, M. (2014) describe the preparation of GO functionalized with amino acids, including glycine (although disclosing only results obtained with 2-aminobutyric acid). However, the teachings of Kumar & Khandelwal are meant to obtain N-doped graphene, with no mention whatsoever of its application as a demulsifier. Additionally, the N-doped graphene obtained by Kumar & Khandelwal is clearly different from the nanodemulsifier comprising GO nanoparticles functionalized with L-glycine of the present invention, in that the electrochemically-obtained GO nanoparticles used for preparing the nanodemulsifier of the invention has a preferable C/O ratio from 3 to 4 as described above, while Kumar & Khandelwal use GO particles with a low C/O ratio of 2. The present inventors have surprisingly found that a higher C/O ratio in the GO nanoparticles allows for a better interaction of the particles with organic solvents, thus favoring a better dispersion thereof in appropriate carriers and increasing their demulsifying efficiency. Additionally, Kumar and Khandelwal obtain functionalized GO nanoparticles with a significantly higher C/O ratio of 8 (i.e., with a higher reduction degree).

Similarly, Bose et al. (2012) disclose the synthesis of glycine-functionalized GO, but starting from a GO with a lower C/O ratio (2.29), and obtaining a final product with a much higher C/O ratio (11.24) than the nanodemulsifier comprising GO nanoparticles functionalized with L-glycine of the present invention.

The nanodemulsifier of the invention is to be applied to the target emulsions in an easily manageable presentation. Correspondingly, it is an aspect of this invention to provide a demulsifying composition comprising the nanodemulsifier comprising GO nanoparticles functionalized with L-glycine according to the invention dispersed in a carrier.

The carrier of the demulsifying composition may be any liquid able to properly disperse the nanodemulsifier particles and maintain said dispersion when applied to the target emulsion, so that the nanodemulsifier may perform its function therein adequately. For instance, the carrier may be a liquid selected from the group consisting of water, methanol, and isopropanol. More preferably, the demulsifying composition comprises isopropanol as a carrier.

The demulsifying composition may additionally comprise a mixture of solvents and surfactants to aid in the migration of the nanodemulsifier of the invention to the interphase of the emulsion. Therefore, in some embodiments of the invention, the demulsifying composition comprises a carrier comprising a mixture of solvents and surfactants.

For example, the carrier may comprise a mixture of solvents, wherein the solvents are selected from the group consisting of water, heavy aromatic solvents, light aromatic solvents such as xylene and toluene, and aliphatic hydrocarbon solvents such as hexane, heptane, octane, etc. In a preferred embodiment, the mixture of solvents comprises water, heavy aromatic solvent, hexane, xylene and toluene.

The surfactants comprised by the carrier according to these embodiments of the invention are well known in the art. In a particular embodiment of the invention, the demulsifying composition comprises a carrier comprising a surfactant selected from the group consisting of ethoxylated nonylphenol 10 (NPE 10), ethoxylated lauryl sulphate, and benzalkonium chloride, more preferably, NPE 10.

In a preferred embodiment of the invention, the demulsifying composition comprises a carrier comprising water, heavy aromatic solvent, hexane, xylene, toluene and NPE 10. In a particularly preferred embodiment of the composition the demulsifying composition comprises a carrier consisting of about 20% v/v water, about 10% v/v heavy aromatic solvent, about 30% v/v hexane, about 15% v/v xylene, about 5% v/v toluene and about 20% v/v NPE 10.

The GO nanoparticles functionalized with L-glycine should be present in the demulsifying composition in a concentration such that the nanodemulsifier concentration in the emulsion once the composition has been applied thereto is sufficient to achieve a proper demulsification. Preferably, the GO nanoparticles functionalized with L-glycine are present in a concentration from about 1000 to about 20000 ppm in the composition. Most preferably, the GO nanoparticles functionalized with L-glycine are present in a concentration of about 10000 ppm in the composition.

### Method of Preparation

The nanodemulsifier comprising GO nanoparticles functionalized with L-glycine of the invention may be prepared by electrochemical exfoliation of a graphite electrode, followed by the functionalization with L-glycine of the GO thus obtained.

The electrochemical exfoliation of graphite is a well-known technique in the art. However, the present inventors have found a novel method for preparing GO which, in comparison with other methods known in the prior art, (i) is less costly, (ii) leads to the generation or a GO with a more homogeneous oxidation, and (iii) increases the efficiency of GO production.

Particularly, the present inventors have studied the hydrodynamics of the electrochemical exfoliation process of a graphite electrode. They found that, surprisingly, by keeping the system under electrolyte recirculation conditions during the electrochemical exfoliation of the graphite electrode, the obtained GO exhibited a homogeneous oxidation degree, and GO production has a high efficiency of over 95% conversion of graphite to graphene.

The term “electrolyte recirculation”, as used throughout the present description, is to be understood as keeping the electrolytic solution of the cell in which the electrochemical process of GO generation under a constant slight movement throughout the entirety of the electrochemical reaction. This can be achieved by several techniques well known in the art, such as, for instance, using a stirring system at a low rotation speed, or natural convection.

From the study of the hydrodynamics of the process, the inventors found that the aforementioned surprising effects associated to the electrolyte recirculation conditions under which the process is carried out, appear to be related to the following observations:
the electrolyte recirculation keeps the exfoliated product suspended (i.e., does not allow it to precipitate);
the exfoliated multilayered flakes maintain their contact with the polarized electrode, thus favoring a complete exfoliation thereof; and
the diffusion of the ions is increased, thus favoring their intercalation between the graphene layers and stimulating the exfoliation process of both the electrode and the exfoliated multilayered flakes.

Correspondingly, it is an aspect of the present invention to provide a method for preparing a nanodemulsifier according to the invention, comprising:
i—electrochemically exfoliating a graphite electrode using an electrolyte recirculating system, thus obtaining GO; and
ii—functionalizing the GO obtained in step i—with L-glycine.

The electrochemical exfoliation of step i—must be carried out in a medium comprising an electrolyte capable of intercalating between the graphene layers of the graphite electrode. The medium may be either acidic, with the electrolyte preferably being H₂SO₄ or a mixture of H₂SO₄ and HNO₃, or neutral, with the electrolyte preferably being (NH₄)₂SO₄.

For the electrochemical exfoliation to take place, the provision of a graphite electrode which will be exfoliated to generate the GO is needed. The other electrode in the electrochemical system, i.e., the counter-electrode, may a priori be any suitable electrode which does not react with the selected medium. In a preferable embodiment, the counter-electrode is a second graphite electrode.

The particular disposition of the electrodes (for example, the distance between them) within the system as well as certain specific parameters of the process (for example, stirring rates) may be adjusted and optimized according to the experimental setup the electrochemical process takes place in, so as to ensure an electrolyte recirculation as required by the invention and an adequate reaction rate. It is within the common knowledge for a person of skill in the art to adjust these parameters in view of the teachings provided in the present description.

Additionally, the present inventors have found that the GO nanoparticles comprised within the nanodemulsifier of the invention may be obtained from industrial-grade graphite as the material for the electrode to be exfoliated. In the state of the art, graphene is typically obtained from high-purity graphite (99.9% purity). Such highly pure graphite is expensive, which renders the mass production of graphene and derivatives thereof from such a raw material a costly endeavor. Industrial-grade graphite (98% purity), on the other hand, is much less expensive. The inventors have found that, by subjecting industrial-grade graphite to a simple cleaning process. Correspondingly, in a preferred embodiment, the graphite electrode is of industrial grade and the method comprises an additional step performed prior to step i-, wherein the graphite electrode is subjected to a cleaning process. For instance, the cleaning process may comprise: washing with H₂SO₄ at 60° C., washing with NaOH 1M at 60° C., and washing with distilled water.

The functionalization of step ii—comprises suspending the GO nanoparticles obtained in step i—and dissolving L-glycine in an appropriate solvent, and maintaining the obtained system stirred during a period of time such that the reaction is complete. Preferably, step ii—comprises suspending the GO obtained in step i—in water and dissolving L-glycine therein, wherein the GO:L-glycine ratio in the system is 1:1. Other reaction parameters, such as duration of the reaction, stirring rate, etc. may be optimized by a person of average skill in the art according to the experimental setup.

The functionalized GO nanoparticles may then be isolated by filtering or centrifugation, and either dried or suspended in an appropriate carrier for their storage.

The preparation method of the nanodemulsifier of the present invention significantly affects its properties. Correspondingly, it is yet another aspect of the invention to provide a nanodemulsifier comprising GO nanoparticles functionalized with L-glycine, wherein the nanodemulsifier is prepared by a method comprising:
i—electrochemically exfoliating a graphite electrode under electrolyte recirculation, thus obtaining GO; and
ii—functionalizing the GO obtained in step i—with L-glycine;
   wherein the graphite electrode is of industrial grade and the method comprises an additional step performed prior to step i-, wherein the graphite electrode is subjected to a cleaning process comprising: washing with H₂SO₄ at about 60° C., washing with NaOH 1M at about 60° C., and washing with distilled water; and wherein the electrochemical exfoliation of step i—is carried out in a neutral medium comprising (NH₄)₂SO₄ as electrolyte.

### Demulsifying Properties

The nanodemulsifier of the invention exhibits excellent demulsifying properties, both for O/W and W/O emulsions. The nanodemulsifier is particularly useful for demulsifying complex emulsions obtained from oil extraction wells.

Oil obtained at extractions sites (also referred to as “crude oil”, which may be used interchangeably with “oil” throughout this description) is often mixed with water in hard-to-break emulsions. The nanodemulsifier of the invention exhibits a surprisingly good demulsifying performance for this kind of emulsions.

Correspondingly, it is yet another aspect of the present invention to provide a method for demulsifying an emulsion comprising crude oil and water, comprising:
i—providing a demulsifying composition according to the invention; and
ii—applying the demulsifying composition to the emulsion.

As mentioned, the nanodemulsifier of the invention exhibits good demulsifying properties both for W/O and O/W emulsions. Therefore, in a particular embodiment of this aspect of the invention, the method comprises applying the demulsifying composition to an emulsion selected from a W/O emulsion and an O/W emulsion.

The demulsifying composition should be applied to the emulsion in an amount sufficient to ensure a proper demulsification. The amount of demulsifying composition to be applied will depend on the characteristics of the emulsion to be treated. For instance, the demulsifying composition may be applied to the emulsion in an amount such that the nanodemulsifier comprising GO nanoparticles functionalized with L-glycine is present at the emulsion in a concentration from about 10 to about 200 ppm. Preferably, the demulsifying composition is applied to the emulsion in an amount such that the nanodemulsifier comprising GO nanoparticles functionalized with L-glycine is present at the emulsion in a concentration from about 100 to about 150 ppm. Most preferably, the demulsifying composition is applied to the emulsion in an amount such that the nanodemulsifier comprising GO nanoparticles functionalized with L-glycine is present at the emulsion in a concentration from 100 to 120 ppm.

The method for demulsifying an emulsion comprising crude oil and water of the invention may comprise additional steps to aid in achieving a complete demulsification. For instance, the method may comprise adding a surfactant to the emulsion along with the demulsifying composition. Preferably, such a surfactant is a polysorbate, more preferably, polysorbate 20. Alternatively, or complementarily, the method may further comprise applying ultrasound to the emulsion after the demulsifying composition has been applied thereto.

In a particular embodiment of the invention, the emulsion comprising crude oil and water to be demulsified is a “slop oil”. A slop oil is a mixture of oil, water and fine solids, which can be frequently found throughout the processes of oil production and constitutes an emulsion which is particularly difficult to break.

When the emulsion comprising crude oil and water to be demulsified is a slop oil, the demulsifying method of the invention comprises:
iii—providing a demulsifying composition according to the invention; and
iv—applying the demulsifying composition to the emulsion;

wherein the demulsifying composition is applied to the emulsion in an amount such that the nanodemulsifier comprising GO nanoparticles functionalized with L-glycine is present at the emulsion in a concentration from about 100 to about 2000 ppm, preferably of about 1000 ppm. Preferably, when the emulsion comprising crude oil and water to be demulsified is a slop oil, the demulsifying method further comprises applying ultrasound to the emulsion after the demulsifying composition has been applied thereto.

### EXAMPLES

The invention will now be further described based on the following examples. It is to be understood that these examples are intended for illustrative purposes only, and by no means should be construed to be limiting the scope of the invention, which is only defined by the appended claims.

### Example 1—Preparation and Characterization of GO in an Acidic Medium

The GO was obtained by electrochemical exfoliation of graphite (99.9% purity, Sigma-Aldrich) in an acidic medium (H₂SO₄/HNO₃: 3/1), applying a voltage of 2 V without stirring, with a distance between the electrodes of 2 cm. The obtained GO is then washed with distilled water, filtered and dried. The product thus obtained is a mixture of GO (approximately 99%), carbon nanotubes and carbon dots.

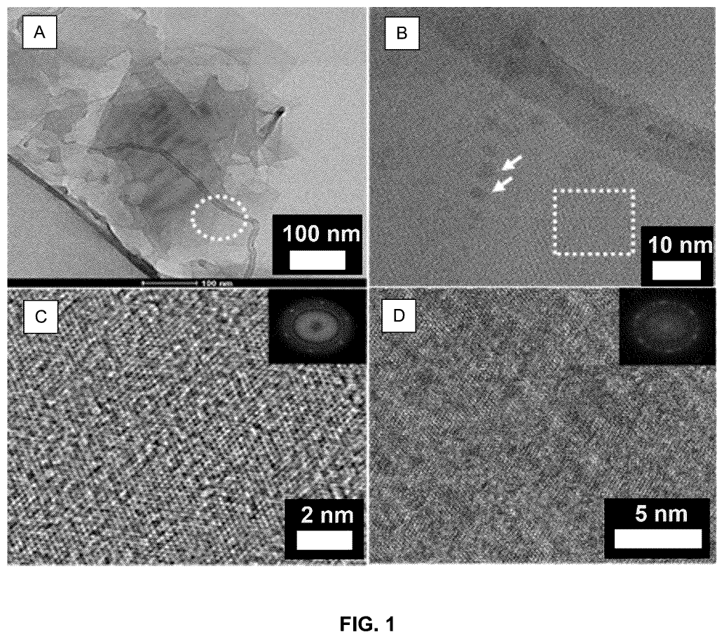

From transmission electronic microscopy (TEM) low-magnification measurements, mainly carbon nanotubes and graphene flakes could be identified. One to two graphene layers were observed, while in some regions many overlapped and disorganized layers were detected. A high-resolution image revealed the presence of what apparently would be graphene dots with a size ranging 3-4 nm. These particles are overlapped with graphene structures of a high crystallinity, as noted with high-resolution TEM (HRTEM) analysis (FIG. 1).

### Example 2—Selection of Amino Acid for Functionalization

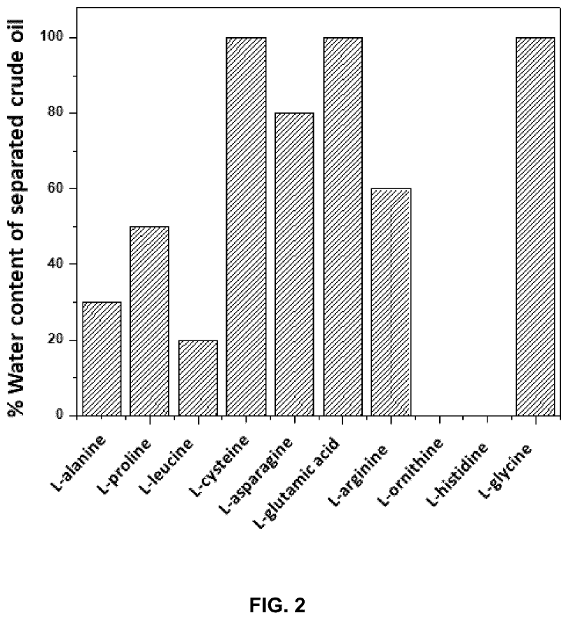

Different amino acids were tested for their demulsifying capabilities. Emulsified crude oil from Lago Fuego 6 (LF06), which is obtained as a W/O stable emulsion, was treated with the following amino acids (1.3 mg/mL): L-alanine, L-proline, L-leucine, L-cysteine, L-asparagine, L-glutamic acid, L-arginine, L-ornithine, L-histidine y L-glycine. The amino acids which exhibited the higher efficiency, with an emulsion break of 100% were: L-cysteine (>5 min), L-glutamic acid (<1 min) and L-glycine (<1 min). L-glycine was selected to continue with the development of the product (FIG. 2).

### Example 3—Functionalization of GO Nanoparticles Obtained with Acidic Exfoliation

The GO was dispersed in water by sonication during 20 minutes. Afterwards, an aqueous solution of L-glycine was added, so that the L-glycine:GO ratio was 11:1. The mixture was then stirred for 1.5 h at 30° C. Then, the suspended solids were filtered and dried. The functionalization was confirmed by UV/vis and Raman spectroscopies.

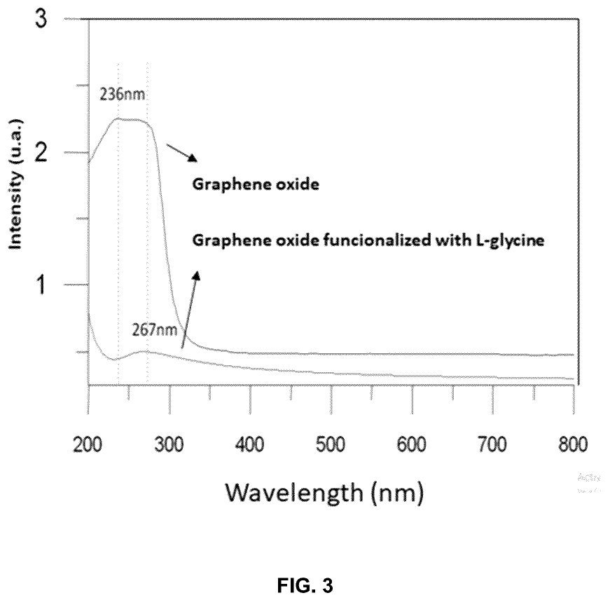

By characterization of the GO and the functionalized GO with UV/vis spectroscopy, two broad bands could be observed. A first band at 236 nm is typical for GO, while a second band at 267 nm corresponds to graphene with a higher reduction degree. The GO obtained from the electrochemical process exhibited both bands overlapped with each other, while the functionalized GO exhibited only the 267 nm band (FIG. 3). This indicates that the functionalization with L-glycine also reduced the GO to some extent.

### Example 4—Demulsifying Performance, Acidic Exfoliation

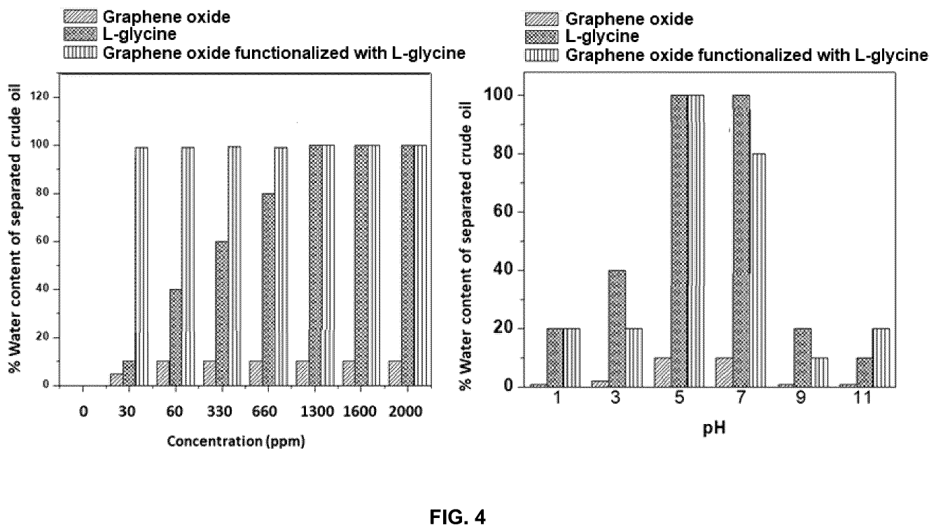

The functionalized GO nanoparticles obtained in Example 3 were tested for their demulsifying capabilities of LF06 crude oil at different concentrations. The assays showed that from a concentration of 30 ppm, the nanodemulsifier of the invention exhibits a superior demulsifying capability in comparison to L-glycine and GO individually (FIG. 4).

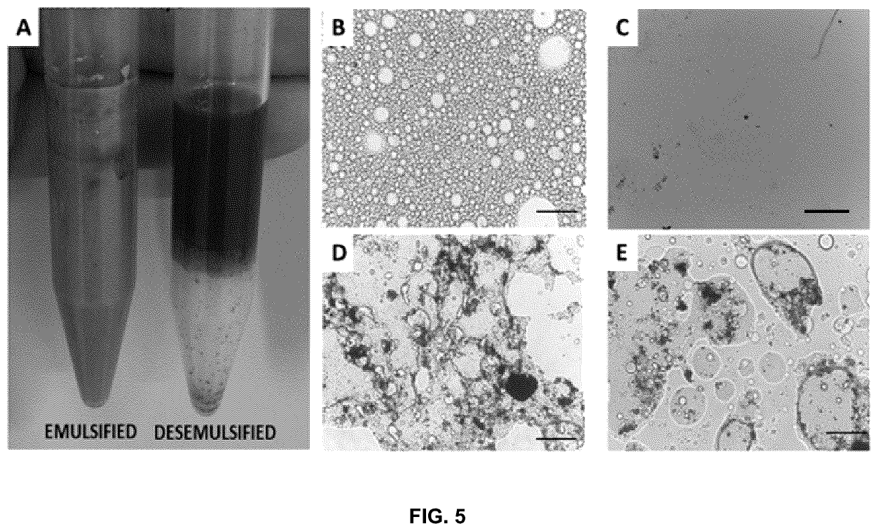

A microscopic analysis of a demulsified sample shows that the functionalized GO nanoparticles are distributed in the interface and the aqueous phase (FIG. 5).

### Example 5—Characterization of Oil and Water after the Demulsifying Process

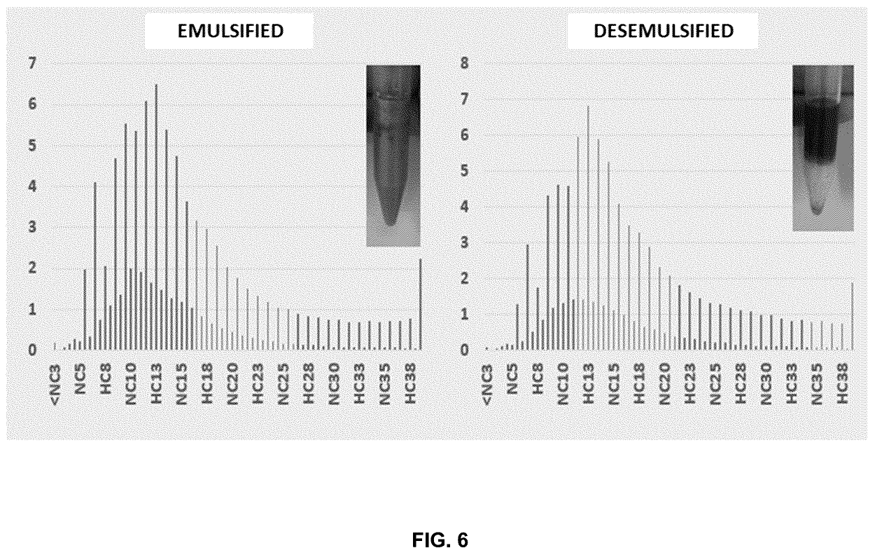

The LF06 crude oil was analyzed prior to and after the demulsification process by chromatography. As observed in FIG. 6, no significant changes in the hydrocarbon fractions present in each sample were observed. Additionally, elements present in the demulsified oil were determined by X-ray fluorescence (XRF), upon which Fe, Ca, K, Cl and S were detected, which are common elements in crude oils. Finally, nitrogen and sulfur contents were determined by XRF as well, which yielded 0.311% N and 0.243% S, which are within expected values for crude oils.

Demulsified water was also analyzed by means of X-ray fluorescence, upon which Ca, K, Cl, S, Br and Sr were detected, which are common elements in crude oils. Additionally, total acid number (TAN) was determined for the demulsified water, obtaining a value of 1.65 mg KOH/g, which may be considered normal (ASTM D664). Also, conductivity (23.6 mS/cm) (ASTM-D1125), total dissolved solids (1.7% p/p CaCO₃ eq.) (MN 2320 B-Ed 22) and superficial tension (25° C., 32.22 mN/m) (ASTM D971) were determined, obtaining values within the expected ranges.

From these results, it can be concluded that the demulsifying process did not affect the quality of either the water or the oil of the initial emulsion.

### Example 6—Preparation and Characterization of GO in a Neutral Medium

Industrial graphite (La Casa del Grafito SRL, Bs. As., Argentina, 98% purity) was subjected to a cleaning process: 1 h wash with 1 M H₂SO₄ at 60° C., which decreases metallic ions, 1 h wash with NaOH 1 M at 60° C., to neutralize and eliminate organic compounds, and then washed with distilled water.

The electrochemical exfoliation was performed using the purified industrial graphite. Two graphite electrodes were used as anode and cathode. A 0.1 M (NH₄)₂SO₄ solution was used as electrolyte, with a pH of 6.5-7. During the electrochemical exfoliation the distance between the electrodes was 1.5 cm, the solution was stirred at 150 rpm, and the temperature was kept at a constant value of 30° C. A positive voltage of 10 V was applied between both electrodes, for 2 h. After the 2 h period, the solution showed a dark grey color. The obtained product was extracted by vacuum filtration using a PTFE membrane with a 0.2 μm pore size, and it was washed three times with distilled water.

During the process, the hydrodynamic aspects thereof were analyzed. It was noted that maintaining an electrolyte recirculation allows for the diffusive phenomena on the electrode's surface to remain stable. A turbulent flow would not allow for a proper exfoliation, since it would detach graphite particles from the electrode.

Therefore, maintaining an electrolyte recirculation is important for the process, as it allows for the multiple contact of the partially exfoliated particles (for instance, graphite, oxidated graphite and multilayered graphene) with the polarized electrode, thus allowing for the exfoliation process to be completed.

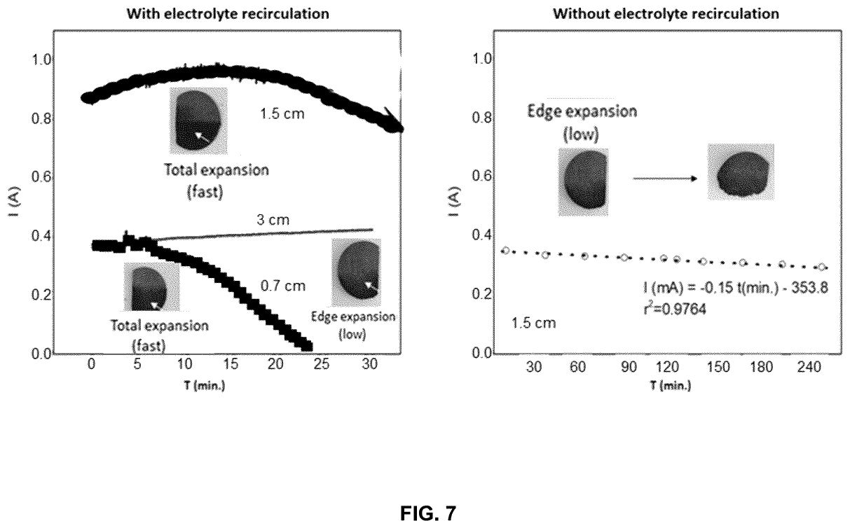

The behavior of the current during the exfoliation process was assayed, both in absence and in presence of electrolyte recirculation. The following observations were made: (i) in absence of electrolyte recirculation, the current decays linearly due to a direct exfoliation in the graphite edges and the decantation of the product; and (ii) when an electrolyte recirculation is applied, depending on the distance between the electrodes, a significant increase in the current is observed due to a first expansion stage, which is maintained for a long time, and then a decay in the current is observed due to the exfoliation process (FIG. 7). To this latter process, the current corresponding to the secondary exfoliation is added.

The distance between the electrodes is another important variable. Assays were performed, considering the exfoliation under an electrolyte recirculation, wherein it was observed that the distance between the electrodes affects directly the exfoliation rate and possibly the quality of the obtained GO. The process was evaluated with 0.7 cm, 1.5 cm and 3.0 cm distance between the electrodes. The initial increase of the current corresponding to the increase in the electrode area due to the diffusion of sulfate over the graphite layers (expansion) is observed at a distance between the electrodes of 0.7 and 1.5 cm, but not at 3 cm. It would appear that the polarization of the electrode, the current distribution between the anode and the cathode and the electrolyte recirculation improve significantly the diffusion of the anion. These effects are reversed when the electrodes are separated, wherein the current decreases and, thus, the diffusion is lower, and also ohmic drop processes take place (which might affect the current distribution between the electrodes). This causes that the expansion process is favored at shorter distances between the electrodes, thus leading to a more homogeneous exfoliation, while at greater distances the exfoliation takes place on the edges of the electrodes (FIG. 7).

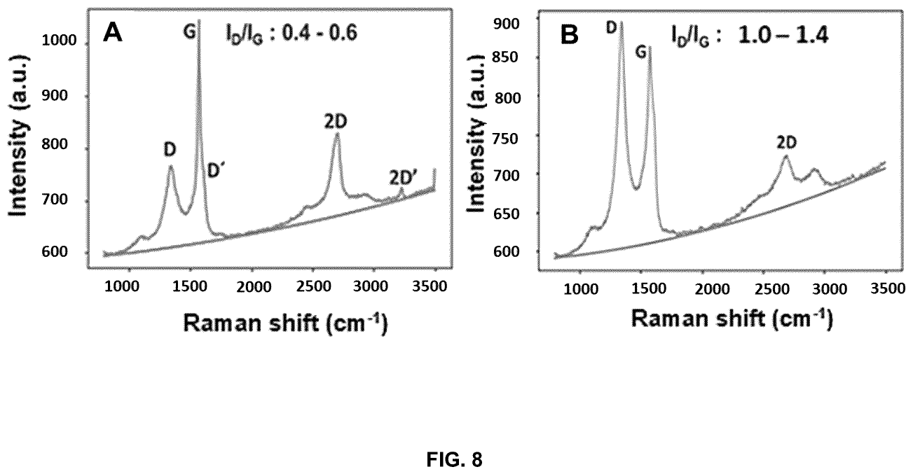

The GO obtained in presence and in absence of electrolyte recirculation was analyzed by Raman spectroscopy (FIG. 8). The obtained spectra indicate that the GO obtained in the absence of electrolyte recirculation conditions exhibited a heterogenous distribution, with different oxidation degrees. However, when the GO is obtained under an electrolyte recirculation, the oxidation state is homogeneous depending on the applied voltage (+/−10 V)

TABLE 2
Different oxidation states of GO obtained in presence
and absence of electrolyte recirculation.

| | | | | | Graphene |
|---|---|---|---|---|---|
| Hydrodynamic | | Graphene oxide grade (I_{D}/I_{G}) | | | (I_{D}/I_{G}) |
| condition | Voltage | 1.2-1.4 | 1.0-1.1 | 0.7-0.9 | 0.4-0.6 |
| None | +10 V | — | — | 83% | 17% |
| | −10 V | — | 53% | 47% | — |
| With electrolyte | +10 V | 100% | — | — | — |
| recirculation | −10 V | — | 100% | — | — |

The GO obtained under electrolyte recirculation was characterized by TEM. The micrographies were obtained with a Talos F200X transmission microscope, operated at 200 keV.

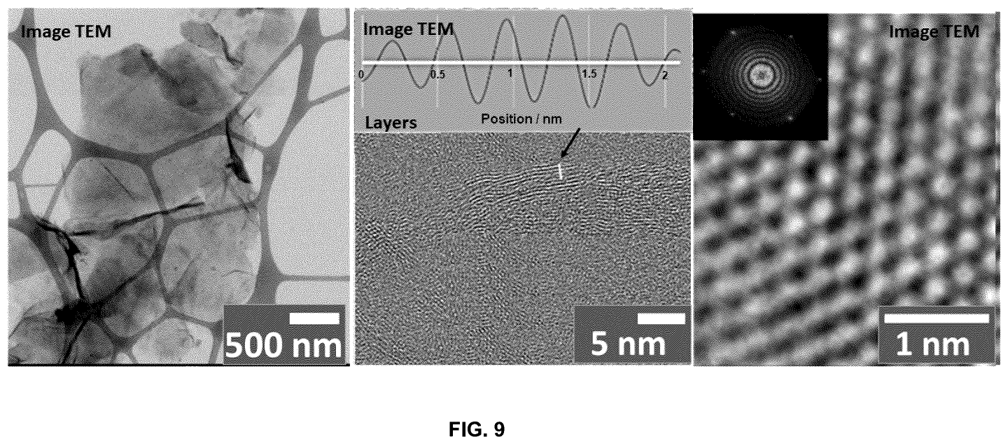

The characterization by TEM allowed the observation of graphene layers with folded regions. From the analysis of the HRTEM images, the typical hexagonal morphology of the graphene network could be observed (FIG. 9)

The results discussed in the previous paragraphs allow to conclude that applying electrolyte recirculation conditions during the exfoliation process leads to the generation of a product with a homogeneous oxidation degree, while also obtaining a higher efficiency in the GO production from other production methods in the art. The presently described method allows for an efficiency higher than 95%, while, for instance, Parvez et al. (2014) report an efficiency of 70%.

The GO obtained with the improved method was then dispersed in water and sonicated for 20 minutes. A stable GO dispersion with a concentration of 1 mg/mL was obtained.

Other polar solvents have proven to be useful for dispersing the GO nanoparticles, such as ethanol and isopropanol.

### Example 7—Functionalization of GO Nanoparticles Obtained with Neutral Exfoliation

The functionalization of the GO particles obtained in Example 6 was carried out by suspending the particles in water and dissolving L-glycine therein so that the w/w GO:L-glycine ratio was 1:1. The reaction was allowed to take place by stirring the mixture at 200 rpm for 2 hours. Then, the functionalized GO nanoparticles were washed with distilled water and ethanol by vacuum filtration, using a 0.25 μm filter, or by centrifugation. After being washed, the functionalized GO nanoparticles were either dried and stored or suspended in isopropanol at a 1000 ppm concentration for their later use in demulsification assays.

The GO nanoparticles were characterized by XPS, both before and after functionalization, to determine the relative concentrations of C, S, N and O comprised therein. The results are shown below in Table 3. The measurements were carried out with a SPECS Flexmod system, using a monochromatic source with an Al anode (1486.61 eV), a power of 100 W and a potential difference of 10 kV.

TABLE 3
Percentage of elements present in non-functionalized
and functionalized GO nanoparticles determined by XPS

| Nanoparticles | C (%) | S (%) | N (%) | O (%) |
|---|---|---|---|---|
| GO | 77.91 | 0.95 | 0.43 | 20.71 |
| GO with L- | 79.49 | 0.28 | 2.46 | 17.78 |
| glycine | | | | |

It can be appreciated by the XPS results that the C/O ratio of the GO nanoparticles increases significantly after their functionalization with L-glycine (from 3.76 to 4.47), indicating the partial reduction of the GO as a result of the functionalization. Additionally, it can be noted that the N level of the GO nanoparticles increases due to the binding of the L-glycine thereto.

The GO nanoparticles were also characterized by Raman spectroscopy, both before and after functionalization, with L-glycine. After functionalization with L-glycine a red shift of the G band was observed, besides of, the increase of I_{D}/I_{G} ratio which is consistent with a dual role of L-glycine as functionalizer and reducing agent.

### Example 8—Demulsifying Performance of W/O Emulsions, Neutral Exfoliation

Synthetic emulsions were prepared using a dehydrated crude oil from Chachahuen (Chus) (southern Mendoza province) taken from the wellhead (26 °API). A synthetic aqueous solution was used to prepare the emulsion, with the following composition: 16.7 g CaCl₂, 50.8 g MgCl₂·6H₂O, 1.5 g Na₂SO₄, 1.2 g NaHCO₃ and 131.8 g NaCl, taken to 1 L with distilled water. The emulsions were prepared as follows: (a) both the crude oil and the aqueous solution were heated to 50° C. for 1 hour; (b) the aqueous solution was first poured into a beaker (15 mL), then the crude oil was added thereto (85 mL), and the mixture was stirred with an Ultraturrax disperser (IKA S25N-18G) for 3 minutes; (c) the obtained emulsion was incubated at 50° C. for the demulsification assays. The final emulsion contained 15% water.

The demulsification assays were carried out as follows:
(a) Emulsion preparation. The emulsion was tempered at the operational temperature from the location where the sample was obtained by heating in an oven.
(b) Dose preparation. The dose is prepared at a defined concentration of the demulsifier, which is dispersed in the selected solvent. The demulsifier is assured to be properly homogenized before being dosed to the emulsion.
(c) Dose administration. The dose is added to the tempered emulsion, in a proportion to be evaluated. The dose is added highly diluted, since only the demulsifying capability is to be assayed. The assays are made in 15 ml conical tubes.
(d) Interaction of the demulsifier with the emulsion. Once the dose was added to the emulsion, the system is stirred for 60 minutes at the operational temperature.
(e) Static separation. After the stirring, the system is left at the same temperature. Every 30 min, a picture is taken, and the separation of phases is evaluated.

Every assay was compared to a commercial demulsifier (DISSOLVAN 044, CLARIANT).

The following parameters were evaluated: (i) selection of the synthesis of the GO nanoparticles functionalized with L-glycine; (ii) selection of the demulsifier concentration; (iii) selection of the dosage volume (dilution); and (iv) temperature evaluation.

i—Demulsifier Synthesis Selection

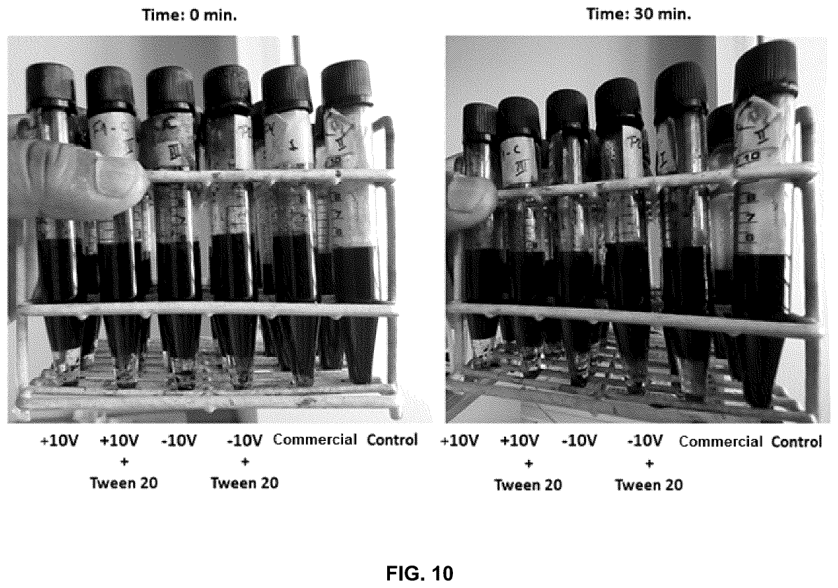

Demulsification assays were carried out to select between the functionalized GO obtained at either −10 V or +10 V. The presence of a surfactant (Tween 20, Sigma-Aldrich) was evaluated as well. FIG. 10 shows that 0 min after the stirring, the tubes containing the functionalized GO nanoparticles of the invention, either obtained at +/−10 V, exhibited a complete separation, either with or without Tween 20. On the other hand, the commercial demulsifier exhibited a low separation at 0 min, achieving a complete separation after 30 min. Therefore, it can be observed that the demulsifier of the present invention allowed for a much faster separation than the commercial one at 100 ppm.

ii—Demulsifier Concentration

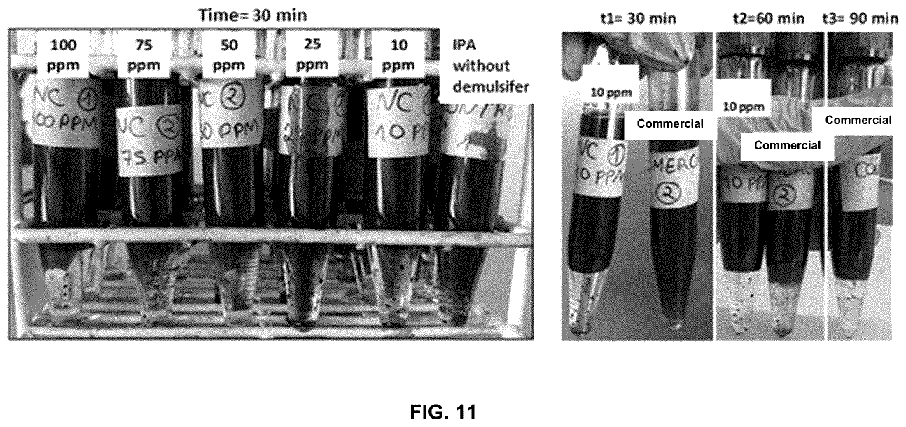

Five concentrations were assayed for the GO particles functionalized with L-glycine obtained with a +10 V voltage (100, 75, 50, 25 and 10 ppm), all of which were able to achieve a complete separation (100% efficiency) after 30 min of incubation in the oven (FIG. 11). Therefore, a 10 ppm concentration was selected as the optimal concentration for further studies.

When comparing the demulsifier of the invention at 10 ppm with the commercial demulsifier, it was observed that the former exhibited a complete separation after 30 min of incubation, while the latter took 90 minutes to achieve the same result (FIG. 11).

iii—Demulsifier Dilution

The dilution of the demulsifier of the invention was evaluated maintaining a final concentration of 10 ppm as determined previously. A separation efficiency over 95% was determined up to a dilution of 1:1000.

iv—Temperature Evaluation

During the temperature evaluation tests, it was observed that the separation efficiency was maintained over 95% at temperatures greater than 50° C. (corresponding to the operational temperature of the treatment plant where the tested crude oil was obtained from).

The performance assays show that, in order to separate crude oil emulsified with 15% water, a final concentration of 10 ppm of GO nanoparticles functionalized with L-glycine (+10 V) dispersed in isopropanol should be added to the emulsion, followed by 30 min of stirring and 30 min of static separation at 50° C. When compared to a commercial demulsifier, a faster separation was achieved by using the demulsifier of the invention.

### Example 9—Demulsifying Performance of a W/O Slop Oil Emulsion, Neutral Exfoliation

A sample of slop oil was obtained from the Luján de Cuyo Industrial Complex (CILC), and it was characterized prior to its demulsification. The emulsion exhibited 40% of emulsified water and 9% of inorganic solids.

Taking into account the complexity of slop W/O emulsions, two strategies were considered for its demulsification: (i) a traditional demulsification method; and (ii) sonochemically assisted demulsification.

i—Traditional Demulsification Method

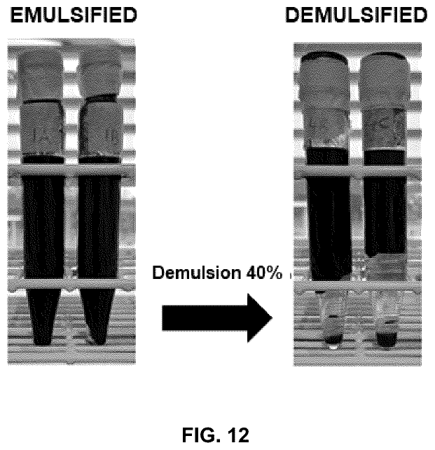

For the separation assay, a dose of 1000 ppm of GO nanoparticles functionalized with L-glycine obtained at +10 V dispersed in isopropanol was prepared, comprising 0.5% Tween 20 as well. The assay was carried out stirring at 70° C. for 1 hour, and then it was monitored statically at the same temperature. Upon 30 min, it could be observed a separation of about 40% of the emulsified water (FIG. 12).

ii—Sonochemically Assisted Demulsification

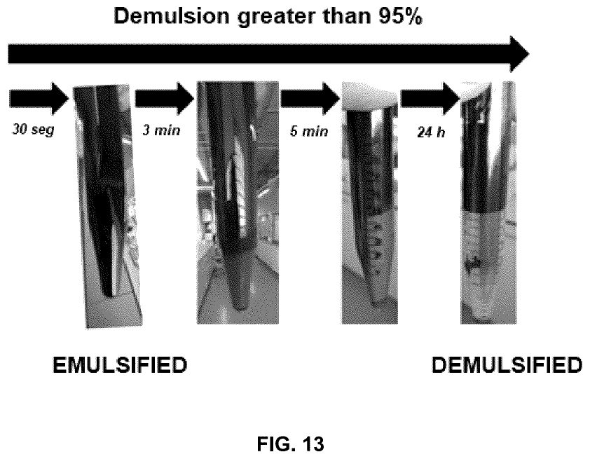

The demulsifier of the invention used in the previous assay, combined with an ultrasound disturbance (40 kHz, 400 W), increases the demulsification in short terms, probably due to an acceleration of the interaction of the demulsifier with the emulgents. A 95% separation was observed in less than 5 minutes, with the aqueous phase comprising initially a suspension of organic solids which after a while return to the interface, thus obtaining a clearer demulsified water (FIG. 13).

### Example 10—Demulsifying Performance of O/W Emulsions, Neutral Exfoliation

Synthetic emulsions were prepared by selecting a crude oil with a high proportion of organic solids (sample obtained from the Neuquén basin), which allows for the stabilization of emulsions. The emulsions contained 5% of crude oil, did not include any surfactant, and they were prepared at a temperature of 50° C. For the demulsification assays, the demulsifier of the invention was compared with a commercial demulsifier (FLOCTREAT 13, CLARIANT).

The emulsions were prepared as follows: (a) both the crude oil and the aqueous solution as described in Example 9 were heated to 50° ° C. for 1 hour; (b) the aqueous solution was first poured into a beaker (90%), then the crude oil was added thereto (10%), and the mixture was stirred with an Ultraturrax (IKA S25N-18G) disperser at 5000 rpm for 15 minutes; (c) the obtained emulsion was incubated at 50° ° C. for the demulsification assays.

The demulsification assays were carried out as follows:
(a) Emulsion preparation. The emulsion was tempered at the operational temperature from the location where the sample was obtained by heating in an oven.
(b) Dose preparation. The dose is prepared at a defined concentration of the demulsifier, which is dispersed in the selected solvent. The demulsifier is assured to be properly homogenized before being dosed to the emulsion.
(c) Dose administration. The dose is added to the tempered emulsion, in a proportion to be evaluated. The assays are made in 15 ml conical tubes.
(d) Interaction of the demulsifier with the emulsion. Once the dose was added to the emulsion, the system is stirred for 60 minutes at the operational temperature.
(e) Static separation. After the stirring, the system is left at the same temperature. Every 30 min, a picture is taken, and the separation of phases is evaluated.

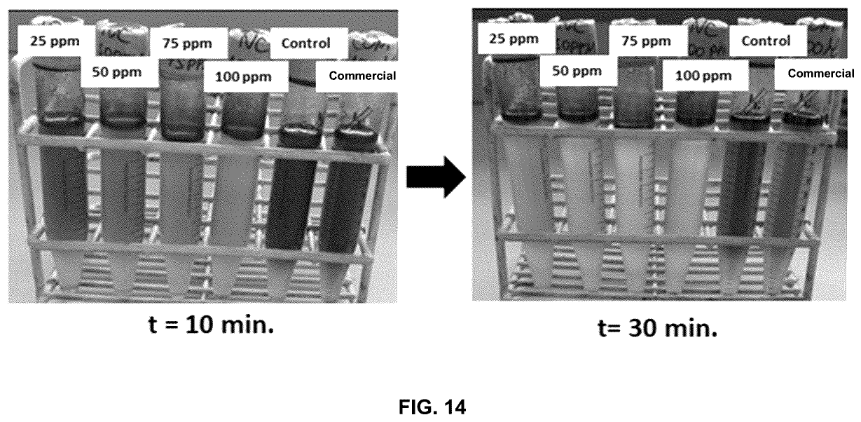

The demulsifier of the invention was dispersed in isopropanol and added to the emulsion at different concentrations (0, 25, 50, 75 and 100 ppm), comparing it with the commercial product. The demulsification process was carried out in the same manner as described in Example 9 for the W/O emulsions. The results indicate a significant demulsion after 30 min, achieving a 100% demulsion when 100 ppm of the demulsifier of the invention are applied, while at 25 ppm a 90% separation was obtained. The commercial demulsifier achieved a demulsion of approximately 50% efficiency (FIG. 14).

The results suggest that to separate an O/W emulsion with 5% crude oil emulsified in water, a final concentration of 100 ppm of GO nanoparticles functionalized with L-glycine obtained at +10 V dispersed in isopropanol is needed, followed by 30 min of stirring and 30 min of static separation at 50° C. When compared to a commercial demulsifier, a more efficient separation was achieved by using the demulsifier of the invention.

### Example 11—Demulsifying Performance on Additional Emulsions, Neutral Exfoliation

Additional tests were carried out on emulsions obtained from different sites, by applying methods as described in Examples 8 to 10, as shown in Table 4 below. For every test in the dosage of maximum efficiency, an efficiency over 95% was observed.

TABLE 4
Demulsification performance of the nanodemulsifier
of the invention on different emulsions

| | | | Composition | Dosage | Max. |
|---|---|---|---|---|---|
| | | % Emulsion | concentration | assayed | efficiency |
| Site | ° API | (W/O) | (ppm) | (ppm) | dosage (ppm) |
| Tierra del Fuego | 44 | 0.05 to 5 | 10000 | 65 to 150 | 100 |
| Neuquén | 26 | 15 | 1000 | 10 to 100 | 100 |
| Mendoza | 13 | 40 | 10000 | 100 to 1000 + | 1000 |
| (SLOP) | | | | sonication | |
| Neuquén | 18 | 10 | 10000 | 10 to 100 | 100 |
| Neuquén | 27 | 25 | 10000 | 10 to 100 | 100 |
| Neuquén | 25 | 1 to 7 | 10000 | 10 to 100 | 100 |
| Neuquén | 40 | 1 to 3 | 20000 | 10 to 100 | 100 |
| Comodoro | 13 | 1 to 40 | 10000 | 10 to 200 | 120 |
| Rivadavia | | | | | |

### Example 12—Preparation of Formulations for Pilot Scale Assays

Formulations based on mixtures of 4 groups of components (functionalized graphene oxide nanodemulsifier, alcohols, surfactants and solvents). The formulations depended on the characteristics of the crude oil to be treated, to ensure:
Stability of the formulations
Diffusion in the crude oil
Release of the active ingredient in zones close to the emulsions
Dispersion capability

The following examples summarize the formulations used in the pilot scale assays.

### Example 13—Validation of Industrial Level Performance (Case I: Neuquén)

The assay was carried out in the Unconventional oil deposit at Neuquén during October 2022. The test was performed during 30 days in a treatment plant with a daily processing capacity of 700-1000 m³.

1500 L of demulsifier were prepared, with the following formulation: GO functionalized with L-glycine 11750 ppm in water (25% v/v), ethoxylated nonylphenol 10 (13% v/v), ethylene glycol (6% v/v) and xylene (56% v/v).

Table 5 below summarizes the crude oil and the treatment conditions:

TABLE 5
Oil and treatment conditions

| | | | Composition | Dosage |
|---|---|---|---|---|
| | | % Input | concentration | assayed |
| Site | ° API | Emulsion (W/O) | (ppm) | (ppm) |
| Neuquén | 44 | 0.05 to 5 | 11750 | 120 to 65 |

The compliance KPI was an output emulsion lower or equal to 0.05%. The plant input and output were monitored by the BSW technique (ASTM 4007). The residence time at the plant was of 4 h and the KPI was fulfilled during all 30 days.

The dosage was evaluated in descending intervals, wherein it was observed that 65 ppm was the optimal concentration (efficiency: 99.9%). Lower concentrations provided decreased efficiencies. The commercial demulsifier (DISSOLVANT®, Clariant) normally used in the plant was applied at 120 ppm.

### Example 14—Validation of Industrial Level Performance (Case II: Neuquén)

The assay was carried out in the Unconventional oil deposit at Neuquén during November 2023. The test was performed during 30 days in a treatment plant with a daily processing capacity of 2500-3200 m³.

4500 L of demulsifier were prepared, with the following formulation: GO functionalized with L-glycine 6000 ppm in water (16.7% v/v), ethoxylated nonylphenol 10 (16.9% v/v), oleic acid (14.2% v/v), butyl glycol (4.7% v/v) and xylene (47.5% v/v).

Table 6 below summarizes the crude oil and the treatment conditions:

TABLE 6
Oil and treatment conditions

| | | | Composition | Dosage |
|---|---|---|---|---|
| | | % Input Emulsion | concentration | assayed |
| Site | ° API | (W/O) | (ppm) | (ppm) |
| Neuquén | 44 | 0.05 to 5 | 6000 | 180 to 90 |

The compliance KPI was an output emulsion lower or equal to 0.05%. The plant input and output were monitored by the BSW technique (ASTM 4007). The residence time at the plant was of 4 h and the KPI was fulfilled during all 30 days.

The dosage was evaluated in descending intervals, wherein it was observed that 90 ppm was the optimal concentration (efficiency: 99.9%). Lower concentrations provided decreased efficiencies. The commercial demulsifier (DODIFLOT®, Clariant) normally used in the plant was applied at 180 ppm.

### Example 15—Validation of Industrial Level Performance (Case III: Comodoro Rivadavia)

The assay was carried out in the Conventional-Tertiary oil deposit at Comodoro Rivadavia during November 2023. The test was performed during 30 days in a treatment plant with a daily processing capacity of 250-500 m³ of heavier oil than the ones treated in Examples 13 and 14.

1000 L of demulsifier were prepared, with the following formulation: GO functionalized with L-glycine 10000 ppm in water (24.6% v/v), ethoxylated nonylphenol 10 (33.4% v/v), oleic acid (11% v/v), butyl glycol (5.3% v/v) and xylene (25.7% v/v).

The incorporation of oleic acid confers to the composition paraffin-dispersing capabilities, thus providing the composition with a dual effect (demulsifier and dispersant).

Table 7 below summarizes the crude oil and the treatment conditions:

TABLE 7
Oil and treatment conditions

| | | | Composition | Dosage |
|---|---|---|---|---|
| | | % Input Emulsion | concentration | assayed |
| Site | ° API | (W/O) | (ppm) | (ppm) |
| Comodoro | 13 | 30-10 | 10000 | 120-80 |
| Rivadavia | | | | |

The compliance KPI was an output emulsion lower or equal to 1%. The plant input and output were monitored by the BSW technique (ASTM 4007). The residence time at the plant was of 3 h and the KPI was fulfilled during all 30 days.

The dosage was evaluated in descending intervals, wherein it was observed that 80 ppm was the optimal concentration (efficiency: 99.9%). Lower concentrations provided decreased efficiencies. The commercial demulsifier (RECOR, Clariant) and dispersant normally used in the plant was applied at 120 ppm.

### REFERENCES

1—Ahmad, A. L., Sumathi, S., Hameed, B. H., 2006. Coagulation of residue oil and suspended solid in palm oil mill effluent by chitosan, alum and PAC. Chem. Eng. J. 118, 99-105. https://doi.org/10.1016/j.cej.2006.02.001
2—Bose, S., Kuila, T., Kumar, A., Kim, N., Lee, J. Dual role of glycine as a chemical functionalizer and a reducing agent in the preparation of graphene: an environmentally friendly method. J. Mater. Chem., 2012, 22, 9696-9703. https://doi.org/10.1039/C2JM00011C
3—Contreras Ortiz, S. N., Cabanzo, R., Mejía-Ospino, E., 2019. Crude oil/water emulsion separation using graphene oxide and amine-modified graphene oxide particles. Fuel 240, 162-168. https://doi.org/10.1016/j.fuel.2018.11.151.
4—Fang, S., Chen, T., Chen, B., Xiong, Y., Zhu, Y., Duan, M., 2016. Graphene oxide at oil-water interfaces: Adsorption, assembly &amp; demulsification. Colloids Surfaces A Physicochem. Eng. Asp. 511, 47-54. https://doi.org/10.1016/j.colsurfa.2016.09.058
5—Franco, C. A., Zabala, R., Cortés, F. B., 2017. Nanotechnology applied to the enhancement of oil and gas productivity and recovery of Colombian fields. J. Pet. Sci. Eng. 157, 39-55. https://doi.org/10.1016/j.petrol.2017.07.004
6—Holmberg, K., 2003. Novel Surfactants, Surfactant Science. CRC Press. https://doi.org/10.1201/9780203911730
7—Jang, J., Pham, V. H., Hur, S. H., Chung, J. S., 2014. Dispersibility of reduced alkylamine-functionalized graphene oxides in organic solvents. J. Colloid Interface Sci. 424, 62-66. https://doi.org/10.1016/j.jcis.2014.03.018
8—Kumar, A., & Khandelwal, M. Amino acid mediated functionalization and reduction of graphene oxide—synthesis and the formation mechanism of nitrogen-doped graphene. New J. Chem., 2014,38, 3457-3467. https://doi.org/10.1039/C4NJ00308J
9—Kokal, S. L., 2005. Crude Oil Emulsions: A State-Of-The-Art Review. SPE Prod. Facil. 20, 5-13. https://doi.org/10.2118/77497-PA
10—Kriipsalu, M., Marques, M., Nammari, D. R., Hogland, W., 2007. Bio-treatment of oily sludge: The contribution of amendment material to the content of target contaminants, and the biodegradation dynamics. J. Hazard. Mater. 148, 616-622. https://doi.org/10.1016/j.jhazmat.2007.03.017
11—Li, Yijiu, Feng Wang, Guoding Zhou, and Yaming Ni. 2003. “Aniline Degradation by Electrocatalytic Oxidation.” Chemosphere 53(10): 1229-34. https://linkinghub.elsevier.com/retrieve/pii/S0045653503005903
12—Liu, J., Li, X., Jia, W., Li, Z., Zhao, Y., Ren, S., 2015. Demulsification of Crude Oil-in-Water Emulsions Driven by Graphene Oxide Nanosheets. Energy & Fuels 29, 4644-4653. https://doi.org/10.1021/acs.energyfuels.5b00966
13—Moosai, R., Dawe, R. A., 2003. Gas attachment of oil droplets for gas flotation for oily wastewater cleanup. Sep. Purif. Technol. 33, 303-314. https://doi.org/10.1016/S1383-5866(03)00091-1
14—Pinazo, A., Manresa, M. A., Marques, A. M., Bustelo, M., Espuny, M. J., Pérez, L., 2016. Amino acid-based surfactants: New antimicrobial agents. Adv. Colloid Interface Sci. 228, 17-39. https://doi.org/10.1016/j.cis.2015.11.007
15—Radnia, H., Rashidi, A., Solaimany Nazar, A. R., Eskandari, M. M., Jalilian, M., 2018. A novel nanofluid based on sulfonated graphene for enhanced oil recovery. J. Mol. Liq. 271, 795-806. https://doi.org/10.1016/j.molliq.2018.09.070
16—Rubio, J., Souza, M., Smith, R., 2002. Overview of flotation as a wastewater treatment technique. Miner. Eng. 15, 139-155. https://doi.org/10.1016/S0892-6875(01)00216-3
17-Safarpour, M., Khataee, A., Vatanpour, V., 2015. Effect of reduced graphene oxide/TiO2 nanocomposite with different molar ratios on the performance of PVDF ultrafiltration membranes. Sep. Purif. Technol. 140, 32-42. https://doi.org/10.1016/j.seppur.2014.11.010
18—Wang, H., Liu, J., Xu, H., Ma, Z., Jia, W., Ren, S., 2016. Demulsification of heavy oil-in-water emulsions by reduced graphene oxide nanosheets. RSC Adv. 6, 106297-106307. https://doi.org/10.1039/C6RA18898B
19—Yu, L., Han, M., He, F., 2017. A review of treating oily wastewater. Arab. J. Chem. 10, S1913-S1922. https://doi.org/10.1016/j.arabjc.2013.07.020
20—Zhang, Yuqing et al. 2009. “Development of a Sulfated Y-Doped Nonstoichiometric Zirconia/Polysulfone Composite Membrane for Treatment of Wastewater Containing Oil.” Separation and Purification Technology 70(2): 153-59. https://linkinghub.elsevier.com/retrieve/pii/S1383586609003992
21—Zheng, C., Brunner, M., Li, H., Zhang, D., Atkin, R., 2019. Dissolution and suspension of asphaltenes with ionic liquids. Fuel 238, 129-138. https://doi.org/10.1016/j.fuel.2018.10.070

1. A nanodemulsifier comprising graphene oxide (GO) nanoparticles functionalized with L-glycine, wherein the GO nanoparticles have a C/O ratio from about 3 to about 6 before being functionalized.

2. The nanodemulsifier of claim 1, wherein the GO nanoparticles have a C/O ratio from about 3 to about 4 before being functionalized.

3. The nanodemulsifier of claim 1, wherein the functionalized GO nanoparticles have a C/O ratio from about 4 to about 7 after functionalization.

4. The nanodemulsifier of claim 3, wherein the functionalized GO nanoparticles have a C/O ratio from about 4 to about 6 after functionalization.

5. A demulsifying composition comprising a nanodemulsifier comprising GO nanoparticles functionalized with L-glycine according to claim 1 dispersed in a carrier.

6. The demulsifying composition of claim 5, wherein the composition comprises isopropanol as a carrier.

7. The demulsifying composition of claim 5, wherein the composition comprises a carrier comprising a mixture of solvents and surfactants, wherein the solvents are selected from the group consisting of water, heavy aromatic solvents, light aromatic solvents, and aliphatic hydrocarbon solvents.

8. The demulsifying composition of claim 7, wherein the mixture of solvents comprises water, heavy aromatic solvent, hexane, xylene and toluene.

9. The demulsifying composition of claim 7, wherein the carrier comprises a surfactant selected from the group consisting of ethoxylated nonylphenol 10 (NPE 10), ethoxylated lauryl sulphate, and benzalkonium chloride.

10. The demulsifying composition of claim 9, wherein the surfactant is NPE 10.

11. The demulsifying composition of claim 7, wherein the demulsifying composition comprises a carrier consisting of about 20% v/v water, about 10% v/v heavy aromatic solvent, about 30% v/v hexane, about 15% v/v xylene, about 5% v/v toluene and about 20% v/v NPE 10.

12. The demulsifying composition of claim 5, wherein the GO nanoparticles functionalized with L-glycine are present in a concentration from about 1000 to about 20000 ppm.

13. The demulsifying composition of claim 12, wherein the GO nanoparticles functionalized with L-glycine are present in a concentration of about 10000 ppm.

14. A method for preparing a nanodemulsifier comprising GO nanoparticles functionalized with L-glycine, the method comprising:
i—electrochemically exfoliating a graphite electrode under electrolyte recirculation conditions, thus obtaining GO; and
ii—functionalizing the GO obtained in step i—with L-glycine.

15. The method of claim 14, wherein step i—is carried out in a neutral medium.

16. The method of claim 15, wherein the neutral medium comprises (NH₄)₂SO₄ as electrolyte for the electrochemical exfoliation.

17. The method of claim 14, wherein step ii—comprises suspending the GO obtained in step i—in water and dissolving L-glycine therein, wherein the GO:L-glycine ratio is 1:1.

18. The method of claim 14, wherein the graphite electrode comprises industrial grade graphite, and wherein the method further comprises an additional step performed prior to step i-, wherein the graphite electrode is subjected to a cleaning process.

19. The method of claim 18, wherein the cleaning process comprises: washing with H₂SO₄ at about 60° ° C., washing with NaOH 1M at about 60° C., and washing with distilled water.
